(19) United States
(12) Patent Application Publication
(10) Pub. No.: US 2025/0077860 A1
(43) Pub. Date: Mar. 6, 2025

(54) DOCUMENT SIMILARITY LEARNING BY HETEROGENOUS GROUP RELATIONSHIPS

(71) Applicant: PAYPAL, INC., San Jose, CA (US)

(72) Inventors: Zhe Chen, Singapore (SG); Jiyi Zhang, Singapore (SG); Quan Jin Ferdinand Tang, Singapore (SG)

(21) Appl. No.: 18/461,299

(22) Filed: Sep. 5, 2023

(51) Int. Cl. G06N 3/08

(52) U.S. Cl. CPC G06N 3/08

(57) ABSTRACT

A system may include a processor and a non-transitory computer readable medium having stored thereon instructions for performing operations including obtaining a first dataset including a plurality of electronic documents and a plurality of entities, extracting, based on one or more rules, one or more subgraphs including representations between one or more electronic documents and one or more entities from the first dataset, identifying one or more groups in the one or more subgraphs, each group including electronic documents and entities selectively identified from a corresponding subgraph based on the representations, and learning the representations associated with the electronic documents and the entities based on the one or more groups and updating the representations in the first dataset. The first dataset may include data corresponding to contextual information associated with the plurality of entities and the representations may be determined based on this contextual information.

### FIELD

The present disclosure relates to the field of machine learning. More particularly, to using machine learning to determine electronic document similarity.

### BACKGROUND

Document verification is a critical process for online transactions. Without such verification, some users may utilize such electronic documents to commit fraudulent transactions. Document verification includes ensuring that the electronic documents submitted by users are authentic and trustworthy. Document similarity algorithms are typically used to identify documents that are semantically similar to each other based on text data to determine relationships between documents and for detecting potential cases of fraud.

### BRIEF DESCRIPTION OF THE DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

FIG. 1 illustrates a block diagram of a system for determining document similarity, according to some embodiments.

FIG. 2 illustrates a block diagram of a portion of the system of FIG. 1, according to some embodiments.

FIG. 3 illustrates a block diagram of a portion of the system of FIG. 1, according to some embodiments.

FIG. 4 illustrates a block diagram of a portion of the system of FIG. 1, according to some embodiments.

FIG. 5 illustrates a method for determining document similarity, according to some embodiments.

FIG. 6 illustrates a block diagram of a network based system, according to some embodiments.

### DETAILED DESCRIPTION

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

Electronic document verification may be performed on electronic documents associated with a user to determine the authenticity or trustworthiness of the documents. The electronic documents are submitted by users of a network such as, for example, web pages, or other electronically generated documents. In a non-limiting example, a user's electronic documents may be in the form of advertisements appearing on web pages advertising the sale of goods or services, which includes titles, seller's information (e.g., user's information), and other descriptive string-based information. Traditionally, techniques for performing document verification identify semantic similarities between electronic documents based on text in the electronic document. However, as fraudulent documents become more sophisticated and more difficult to distinguish, traditional document similarity checking methods have limitations in terms of accuracy and scalability.

Various embodiments of the present disclosure relate to systems, devices, computer-implemented methods, and computer readable medium including one or more techniques and/or algorithms for performing document similarity checking on a heterogeneous document network by associating electronic documents with different types of entities using different types of contextual information. For example, the different types of contextual information can include user behavior data, device data, IP addresses, profile data, policies, other contextual information, or any combinations thereof. In some embodiments, the heterogeneous document network may be associated with a user. In other embodiments, the heterogeneous document network may be associated with a plurality of users.

The document checking techniques generate representations that include the corresponding Meta-Group relationship information, and which incorporates the contextual information into the document representation. These representations can be used in downstream tasks in the network such as for fraud detection and prevention purposes. For example, the representations may be able to detect sophisticated fraud attempts in a network involving multiple documents and different types of information. In another example, representations corresponding to relationships between a user's electronic documents, device data, and corresponding IP addresses can be used to perform document verification for online payment processors.

Various embodiments of the present disclosure may be a system that utilizes contextual information to build the Meta-Groups that may be used to model different relationship groups and may be used to identify document similarities by analyzing and modeling the Meta-Groups. In this regard, the system includes an architecture for determining representations using Meta-Groups and indicative of relationships between entities in a dataset including electronic documents and the other different entities.

The system determines the Meta-Groups based on Meta-Paths, which the system identifies by leveraging domain knowledge and/or data driven methods. The Meta-Paths may be a sub-graph, which captures the different entities and corresponding relationships between the entities determined based on one or more definitions. In some embodiments, the Meta-Paths may capture the different entities and corresponding relationships based on semantic relationships between different entities.

The Meta-Path sub-graphs include entities (e.g., nodes) of one or more different entity types and corresponding edges between the entities. The entities may be graph-based representations of the different types of contextual information. For example, the different entity types may include a particular user's devices, IP addresses, online profile, completed transactions, electronic documents, other entity types, or any combinations thereof. Additionally, the edges are vector representations having a given dimension and indicative of relationships between the different entities. The system may obtain one or more definitions as input and may determine the Meta-Paths (e.g., sub-graphs) based on the one or more definitions. In some embodiments, the definitions for determining the Meta-Paths may be obtained by the system from a user associated with the platform of the system such as, for example, data scientists or engineers responsible for building and maintaining the system. For example, the one or more definitions may associate malicious activity indicative of fraud on the network with certain electronic documents of a certain user and the system may apply the document similarity checking techniques to determine sub-graphs representative of relationships between the certain electronic document and other entities including the user's profile, computing device(s), IP address(es), and other entities having relationships with the certain electronic documents. As used herein, the term “domain knowledge” refers to the understanding of the relationships and interactions between different entities in a dataset based on knowledge and experience of a domain expert such as, for example, a data scientist or other user associated with the domain. As used herein, the term “data-driven methods” refers to methods involving analyzing data to identify patterns and relationships between entities that may not be readily apparent based on the data.

The system leverages the Meta-Paths to determine the Meta-Groups, the Meta-Groups corresponding to representations of local relationships in the Meta-Path sub-graph. The system leverages these Meta-Groups and models different relationship groups between the entities in the heterogeneous document network. In this regard, based on each respective Meta-Group, the system may add a node to the document network and determine edges connecting the node to the other entities in the corresponding group. In some embodiments, the system may leverage the dataset including the node groups to train one or more machine learning model for determining document similarity in a dataset. For example, a machine learning model may be trained based on the representations to identify and prevent future instances of malicious activity on new electronic documents that have not been associated with one of the nodes in the heterogeneous document network.

The system may apply the document similarity checking techniques to categorize data in a dataset into Meta-Paths and Meta-Groups to enable the system to perform one or more downstream operations such as, for example detecting malicious electronic document submissions by a user. The system performs the document similarity checking techniques to the data corresponding to the heterogeneous document network by considering both internal and external relationships to perform the categorization and to determine representations indicative of relationships between one or more entities from the entities in the dataset. In some embodiments, the dataset may include the representations indicative of the relationships between the different entities. For example, the dataset may include representations determined by a previous iteration of a machine learning model.

The dataset may include the heterogeneous document network, representations, Meta-Groups, Meta-Paths, other data, or any combinations thereof. The system may apply the one or more document similarity checking techniques to the dataset and may determine new Meta-Groups based on new Meta-Paths for determining representations that categorize the electronic documents and the other entity types in the dataset based on the corresponding Meta-Groups. In some embodiments, the system may apply the document similarity checking techniques to the dataset and may generate an updated dataset as output. In some embodiments, the updated dataset may include previous iterations of the data, and may also include the new representations, Meta-Groups, Meta-Paths, other like data, or any combinations thereof. Furthermore, the system may train a machine learning model based on the new dataset and/or the new Meta-Groups to enable improved identification of document similarity in a heterogeneous document network.

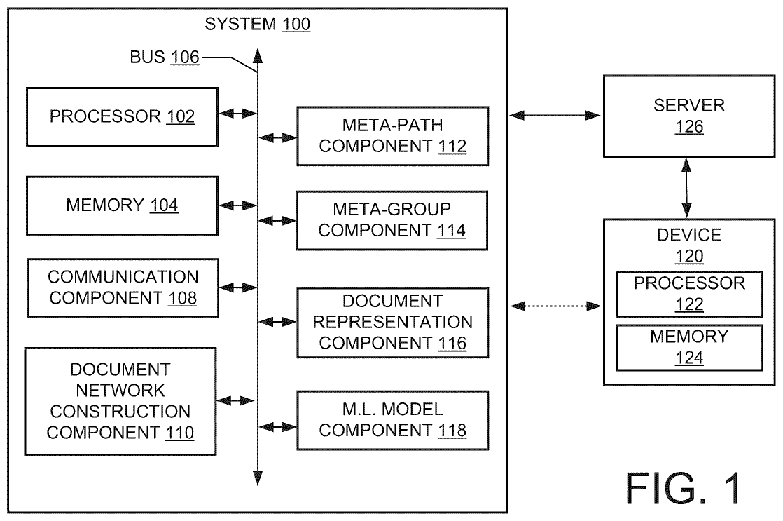

FIG. 1 illustrates a non-limiting example of a system 100 for determining document similarity, according to some embodiments. System 100 may be a computerized tool (e.g., any suitable combination of computer-executable hardware and/or computer-executable software) which can be configured to identify document similarity by determining heterogeneous group relationships having different entity types and using contextual information. The system 100 may include one or more of a variety of components, such as a processor 102, memory 104, bus 106, communication component 108, document network construction component 110, Meta-Path component 112, Meta-Group component 114, document representation component 116, and a machine learning (M.L.) component 118.

In some embodiments, the system 100 and/or any of the components included in the system 100 may be configured to utilize hardwired circuitry that may be used in place of or in combination with software instructions to implement features consistent with principles of the disclosure. Thus, implementations consistent with principles of the disclosure are not limited to any specific combination of hardware circuitry and software. For example, various embodiments may be embodied in many different ways as a software component such as, without limitation, a stand-alone software package, a combination of software packages, or it may be a software package incorporated as a “tool” in a larger software product. For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

The system 100 includes processor 102 and memory 104. In some embodiments, the processor 102 may include one or more processors for performing operations as will be described herein. The memory 104 may be a non-transitory computer readable medium having stored thereon instructions executable by the processor 102 to perform operations as described herein. In some embodiments, the system 100 may be in communicable connection with computing device 120 for performing the one or more operations. In some embodiments, the computing device 120 may include a processor 122 and a memory 124 having stored thereon instructions executable by the processor 122 to perform the operations as described herein.

The system 100 may store one or more datasets in the memory 104 for use by the other components of the system 100. The one or more datasets may include data corresponding to heterogeneous document networks, augmented heterogeneous document networks, Meta-Path definitions, Meta-Path sub-graphs, Meta-Group sub-graphs, corresponding representations, machine learning models, other like data, or any combinations thereof. In some embodiments, the system 100 may obtain data corresponding to the heterogeneous document network from an external computing device, such as computing device 120, and store the data in the memory 104. In other embodiments, the system 100 may obtain one or more machine learning models from an external computing device, such as computing device 120, and store the data in the memory 104. It is to be appreciated by those having ordinary skill in the art that the data included in the dataset for identifying document similarity by the system 100 is not intended to be limiting and may include data consistent with principles of the disclosure and/or may include other data that may not be described in the disclosure.

The system 100 may include one or more components that are communicatively and/or operably coupled to one another to perform one or more functions of the system 100. In some embodiments, each of the components of the system 100 may be communicatively or operatively coupled to one another via the bus 106. In other embodiments, each of the components of the system 100 may be communicatively coupled to one another via the communication component 108.

The system 100 may include the communication component 108. The communication component 108 can send and receive data between the one or more components of the system 100. The system 100 may also enable the system 100 to send and receive data between system 100 and other external computing devices, such as computing device 120. In some embodiments, the communication component 108 can send and receive one or more datasets to computing device 120 for distribution of processing loads for performing the document similarity identification techniques of the present disclosure.

It can be appreciated that the communication component 108 can possess the hardware required to implement a variety of communication protocols (e.g., infrared (“IR”), shortwave transmission, near-field communication (“NFC”), Bluetooth, Wi-Fi, long-term evolution (“LTE”), 3G, 4G, 5G, 6G, global system for mobile communications (“GSM”), code-division multiple access (“CDMA”), satellite, visual cues, radio waves, etc.) The system 100 and/or various respective components can additionally comprise various graphical user interfaces (GUIs), input devices, or other suitable components.

The system 100 may include a document network construction component 110. The document network construction component 110 enables the system 100 to associate a user's electronic documents with different entity types included in the network. In some embodiments, the electronic documents, along with the contextual information associated with the other entities, may be stored on a particular platform used by the user. For example, a platform of an online merchant used by the user to offer goods or services for sale. In other embodiments, the electronic documents may be stored on a particular machine of the user.

To build a document network for associating a user's documents with the different entity types, the document network construction component 110 may collect and integrate various types of contextual information, which may be obtained from a plurality of different sources. Examples of contextual information may include, but is not limited to, user behavior data, device data, IP address data, user profile data, policy rules, other data types, or any combinations thereof, according to some embodiments. In another example, the contextual information may include user behavior data generated based on the user engaging in transactions on the platform associated with the system 100. It is to be appreciated by those having ordinary skill in the art that the contextual information and corresponding different entity types included in the system 100 are not intended to be limiting and may include any of a plurality of different entity types in accordance with the present disclosure. It is also to be appreciated by those having ordinary skill in the art that the source of the contextual information is not intended to be limiting and the information may be obtained from any of a plurality of sources in accordance with the present disclosure.

In some embodiments, the system 100 may include applying data cleaning and normalization techniques to ensure consistency and accuracy in the collected data. The data may then be used by the system 100 to build the document network that enables the document network construction component 110 to associate a user's electronic documents with heterogeneous data by identifying the relationships and connections between those different entities, as will be further described herein.

The system 100 includes a Meta-Path component 112. The system 100, and the Meta-Path component 112 in particular, leverages domain knowledge of the system 100 to generate a sub-graph that captures the semantic relationships between the different entities and the different types of entities in the document network. As such, the Meta-Paths are sub-graphs having a sequence of two or more entities and corresponding relationships between the entities. For example, a Meta-Path may be a sub-graph representative of a sequence of entities including a certain user's profile and one or more computing devices and relationships between the user's profile and the one or more computing devices, which the system 100 determines based on the user profile data and the device data.

The Meta-Paths may be represented computationally in a variety of ways including, but not limited to, data structures such as, for example, adjacency matrices (directed or undirected), adjacency list, adjacency sets, incidence matrices, other representations, or any combinations thereof. In some embodiments, the Meta-Paths can be defined as:

$$MP = {E}_{1} -> {R}_{1} -> {E}_{2} -> {R}_{2} -> {E}_{2} … {R}_{n} -> {E}_{n} ,$$

where Eᵢ represents a type of entity and Rᵢ represents a type of relationship. For example, in the context of document verification, a Meta-Path may describe the relationship between a user's document and an IP address, where the document is uploaded by the user through a typical IP address group, according to some embodiments. In another example, the Meta-Path may describe the relationship between a user's document based on the policy rules of the network and based on the device type, where the document was submitted by a certain laptop model and the document is being submitted to try and meet certain criteria of the network for document verification purposes, according to some embodiments.

The system 100 includes a Meta-Group component 114. The Meta-Group component 114 identifies Meta-Group relationships between entities based on the Meta-Paths. As such, the Meta-Group component 114 may generate a respective sub-graph based on each defined Meta-Path. In this regard, each sub-graph generated by the Meta-Group component 114 is a graph that may include entities connected by a certain Meta-Path. In some embodiments, the Meta-Group component 114 may, based on the Meta-Path, generate a sub-graph that may include therein entities that are connected by only one specific Meta-Path. Thus, each sub-graph modeled by the Meta-Group component 114 may be based on a specific Meta-Path relationship. For example, for a Meta-Path sub-graph defined based on parameters corresponding to “IP-device-profile,” the Meta-Group component 114 may perform group detection on this Meta-Path and identify internal relationships from this specific Meta-Path.

After the Meta-Group component 114 detects the Meta-Group for each Meta-Path, the Meta-Group component 114 may add new nodes to the original document network. Each node represents a specific group determined from its corresponding Meta-Path relationship. The Meta-Group component 114 may also connect the node to all the entities in the original document network which belong to it, thereby providing as output an augmented document network. In some embodiments, the Meta-Group component 114 may connect each respective node to the entities that belong to it by referring to the relationships in each Meta-Path sub-graph. For example, the Meta-Group component 114 may identify the corresponding entity types to be connected to the node based on the Meta-Path sub-graph, which describes a sequence including entities and representations determined based on “IP-device-profile” definition.

In some embodiments, the Meta-Group component 114 may perform the Meta-Group detection on new data or data that may not have previously been analyzed for document similarities. In other embodiments, the Meta-Group component 114 may perform the Meta-Group detection on an augmented document network that includes one or more nodes and corresponding group relationships based on applying one or more previous iteration models to the document network. In this regard, the system 100 may identify one or more new Meta-Groups based on the augmented document network and the system 100 may determine correlations between existing Meta-Groups and new Meta-Groups to determine higher level relationships in the data. For example, the system 100 may determine a correlation between an existing Meta-Group and a new Meta-Group, the new Meta-Group being identified as fraudulent activity by the system 100, and thereby marking the existing Meta-Group as also corresponding to fraudulent activity based on the association with the newly identified Meta-Group.

The system 100 may include a document representation component 116. The document representation component 116 may learn new representations by building an augmented data network graph that retains the diverse relationships identified based on the different Meta-Groups (and the different Meta-Paths). For each entity identified in the new representations, the document representation component 116 may initialize the features of the corresponding entities and determine relationships with a new node associated with a corresponding one of the representations. The document representation component 116 may initialize the features by encoding the text data of the corresponding entities into embeddings for determining the edges between the entities and the node, which are indicative of relationships with the corresponding node. In some embodiments, the text data may be related to the entity. In other embodiments, the text data may be part of the entity. In certain other embodiments, the text data may be representative of the entity. For example, the text data may be the specific IP address associated with a particular computing device. In some embodiments, the document representation component 116 may use siamese and triplet network structures to output embeddings indicative of the semantic relationships that can be compared using cosine-similarity. In some embodiments, text data encoding may be performed using Natural Language Processing (“NLP”) models. For device data, the document representation component 116 may use one or more methods to encode the embeddings generated as output into the edges connecting the entities. In other embodiments, for sequential device data (e.g., mouse, typing), the document representation component 116 may extract biometric features as the embeddings and may encode these embeddings as the initial edges.

Accordingly, once the document representation component 116 determines the edge relationships between the entities for each representation, the document representation component 116 may transform the representations to map the edges to the same space as the original document network. In some embodiments, the transformation performed by the document representation component 116 may be defined as:

$${h}^{{e}_{i} ′} = {T}^{{e}_{i}} \cdot {h}^{{e}_{i}} ,$$

where h^{ei} represents the feature of entity eᵢ and T^{ei} represents the transformation weight of entity eᵢ. This weight of transformation is learnt during model training, as will be further described herein.

After the entities are transformed into the same space, the document representation component 116 may update the representation of each entity. In some embodiments, the update to the representation of each entity may be performed by the document representation component 116 and defined as:

$${x}_{i}^{0} = {h}^{′} \\ {x}_{i}^{k + 1} = σ ( {\sum }_{j ∈ {N}_{i}} {a}_{ij} \cdot {x}_{j}^{k} \cdot W ) ,$$

where xᵢ^{k} is the representation of entity eᵢ in the k-th iteration (e.g., previous iteration). Nᵢ represents the entities that are connected to entity eᵢ. aᵢⱼ is the weight on the connection between entity eᵢ and eⱼ, the default value being 1. W is the weight of a transformation of the representation relative to the previous iteration representation.

In the augmented document network, each entity will receive messages from different entities also in the Meta-Group. Thus, the representation of each entity is updated to include relationships with the node and the other entities in the Meta-Group based on these messages. As such, the document representation component 116 augments the original document network with the Meta-Group nodes, which work as a hub by connecting to the other entities in the Meta-Group to enable the exchange of messages between the entities, and to ensure the relationships from each Meta-Path is captured in the representation in the augmented document network.

The system 100 includes a M.L. component 118. The M.L. component 118 may be configured to apply the methods and/or techniques as described herein to identify document similarity based on different entity types. Furthermore, the system 100 may utilize the M.L. component 118 to improve the document similarity identification process by iteratively training a machine learning model using data corresponding to a document network having a plurality of entities of different entity types and augmented based on the Meta-Groups and corresponding nodes to enable learning of high level relationships between entities. As such, the system 100 may apply the one or more models to a document network to perform a variety of actions. For example, the M.L. component 118 may be utilized to identify new electronic documents originating from a certain IP address tagged on the platform as being a source of fraudulent advertising activity, and to enable the system 100 to take automated action with high degrees of confidence. In some embodiments, the M.L. component 118 may apply a utility-based analysis to weigh the benefit of acting in response to a correct determination of fraud versus the risk of acting in response to a false positive determination of fraud and may perform one or more further actions based on the analysis. In other embodiments, the M.L. component 118 may apply a probabilistic or statistical-based analysis in connection with the foregoing and/or the following as will be further described herein.

The system 100 may utilize the M.L. component 118 to apply the one or more techniques noted above to the document network data to perform document similarity identification on new entities based on the contextual information that may not previously have been analyzed by the system 100 using the one or more techniques herein. The system 100 may apply the M.L. component 118 along with one or more of the other components to determine relationships between a new entity added to the document network and other entities in the document network to determine relationships therebetween. For example, the M.L. component 118 may utilize the augmented document network to detect downstream binary malicious attacks in the network.

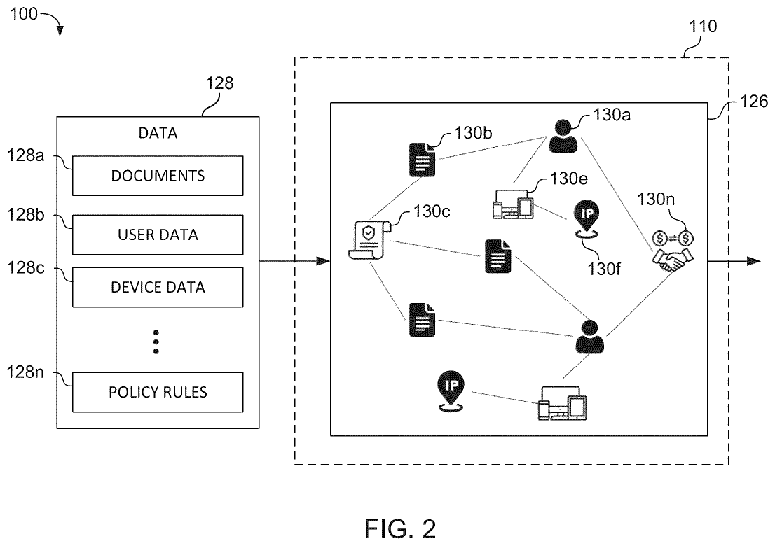

FIG. 2 illustrates a block diagram of a portion of the system 100, according to some embodiments.

The system 100 may build a heterogeneous document network 126 based on the data 128 corresponding to the various types of contextual information obtained as input. In some embodiments, the data 128 may include the heterogeneous document network 126. In other embodiments, the data 128 may be stored in the memory 104 and the system 100 may build the heterogeneous document network 126 based on the data 128 in the memory 104.

In this regard, as shown in FIG. 2, the system 100 may obtain data 128 corresponding to the contextual information. In some embodiments, the data 128 may include data 128a to data 128n, and hereinafter referred to as data 128. The data 128 may include different types of contextual information corresponding to, for example, electronic document data, user data, device data, and policy rules associated with the user. In this regard, the different entity types included in the heterogeneous document network 126 may be based on the contextual information included in data 128. For example, in some embodiments, the heterogeneous document network 126 may include entity 130a to entity 130n, hereinafter referred to as entities 130, and which may be representative of any of a plurality of different entity types based on the data 128. For example, in some embodiments, the different entities may include, but are not limited to, electronic documents, computing devices, IP addresses, user profiles, and policy rules. However, it is to be appreciated that the heterogeneous document network 126 may also include any of a plurality of other entity types in accordance with the present disclosure.

In some embodiments, the heterogeneous document network 126 may include previously determined representations between the entities 130 based on one or more previous Meta-Groups applied to the original or previous iteration of the heterogeneous document network 126.

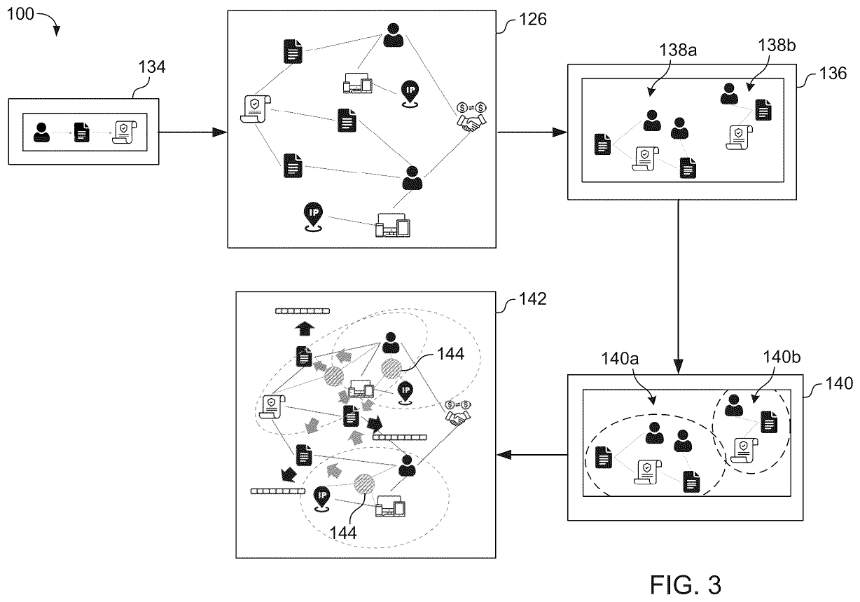

FIG. 3 illustrates a block diagram of a portion of the system 100, according to some embodiments.

The system 100 obtains definitions 134 defining a sequence of entities and corresponding relationships to extract as a Meta-Path sub-graph 136 from the entities and relationships in the heterogeneous document network 126. The definitions 134 may be provided as input at the system 100 by one or more other users associated with the system 100. For example, the other users may be data scientists associated with the online entity that build and maintain the platform of the system 100. In some embodiments, the definitions 134 may include different entities 130 to be extracted from the heterogeneous document network 126 in the sub-graph 136. In other embodiments, the definitions 134 may include one or more graph variables or parameters associated with a certain user. For example, the definitions 134 may seek to identify entities associated with a certain user's name, goods, or services and that are identified as being associated with malicious activity. In another example, the definitions may include a certain user's name, services, and goods, and the system 100 may determine a sub-graph 136 including entities 130 corresponding to the user's electronic documents, completed transactions, computing devices, and IP addresses.

Based on the definitions 134, the system 100 may extract a sequence of entities and corresponding relationships including one or more different entity types. In some embodiments, based on the definitions 134, the system 100 may extract a sequence of entities and corresponding relationships including two or more different entity types. For example, the definitions 134 may include a certain user's name, website, services, goods, and other like information, and the system 100 may identify a sequence from the heterogeneous document network 126 including entities 130 and relationships between the sequence of entities 130. In some embodiments, the Meta-Path sub-graph 136 may be a continuous sequence that includes the entities and their relationships. In other embodiments, the sub-graph 136 may include one or more sequences of entities and relationships extracted from the heterogeneous document network 126.

Referring to FIG. 3, based on the definitions 134, the system 100 extracts sub-graph 136 from the heterogeneous document network 126. The sub-graph 136 includes sequence 138a and sequence 138b extracted from heterogeneous document network 126 based on the definitions 134. Each of the sequence 138a and sequence 138b having two or more different types of entities and each including two or more entities 130 and corresponding relationships between the two or more entities 130.

The system 100 may identify a Meta-Group 140 based on the Meta-Path sub-graph 136. The Meta-Group 140 may be a sub-graph including entities 130 and corresponding relationships from sub-graph 136. In some embodiments, the Meta-Group 140 may include the sequence of entities from sub-graph 136. In other embodiments, the sub-graph 136 may include two or more sequences and the Meta-Group 140 may include one of the sequences from the sub-graph 136. Referring to FIG. 3, the system 100 may extract, based on sub-graph 136, Meta-Group 140a corresponding to sequence 138a and Meta-Group 140b corresponding to sequence 138b. In this regard, each of the Meta-Group 140a and Meta-Group 140b include the different entities 130 and corresponding relationships connecting the different entities 130 of sequence 138a and sequence 138b.

The system 100 learns the representations of the entities 130 in the heterogeneous document network 126 based on the Meta-Group 140 and builds an augmented document network graph 142 to retain the diverse relationships identified based on the Meta-Group 140. To build the augmented document network graph 142, the system 100 initializes the features of the entities 130 in the heterogeneous document network 126 that correspond to the entities 130 in the Meta-Group 140. The system 100 encodes the features into embeddings and associates the entities 130 in the heterogeneous document network 126 with a node 144 based on the embeddings. In this regard, the system 100, based on the embeddings, transforms the representations to map the entities 130 in the same space as the heterogeneous document network 126 to produce as output the augmented document network graph 142. Each entity 130 in the augmented document network graph 142 may be configured to receive messages from the other entities 130 also connected to the node 144. In this regard, the node 144 serves as a hub to enable the exchange of messages between the entities 130 in the augmented document network graph 142 that corresponds to the entities in each Meta-Group 140.

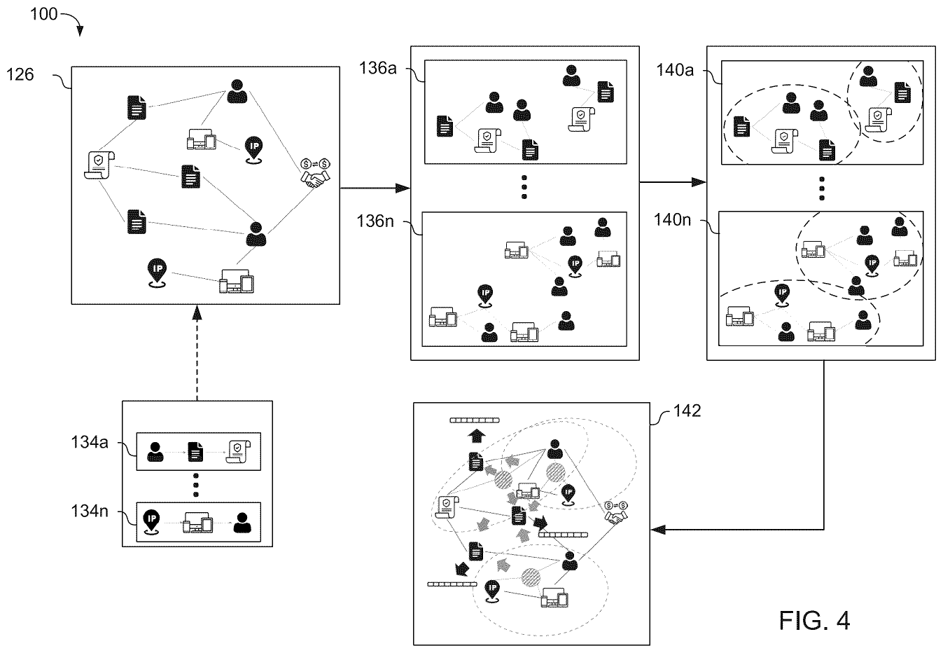

FIG. 4 illustrates a second block diagram of a portion of the system 100, according to some embodiments.

The system 100 may obtain one or more definitions 134 provided as input to the system 100 and determines the one or more of the sub-graph 136 based on the definitions 134. Referring to FIG. 4, the system 100 obtains definitions 134a through definitions 134n. hereinafter referred to as definitions 134. Based on definitions 134, the system 100 extracts sub-graph 136a through sub-graph 136n, hereinafter referred to as sub-graphs 136, from the heterogeneous document network 126. Each of the sub-graphs 136 include a sequence of entities 130 and relationships connecting the sequence of entities 130.

The system 100 may also determine one or more Meta-Groups 140 based on the sub-graphs 136. In some embodiments, based on each one of the sub-graphs 136, the system 100 may determine a corresponding Meta-Group 140. In other embodiments, the system 100 may determine one or more Meta-Group 140 for each one of the sub-graphs 136. For example, the system 100 may determine a Meta-Group 140 for each individual sequence in the sub-graph 136. Referring to FIG. 4, the system 100, based on the sub-graphs 136, determines Meta-Group 140a through Meta-Group 140n, hereinafter referred to as Meta-Groups 140.

The system 100 determines each Meta-Group 140 and learns the representations for the entities in the Meta-Group 140. The system 100 may also build the augmented document network graph 142 that retains the diverse relationships identified from the Meta-Group 140. To build the augmented document network graph 142, the system 100 initializes the features of the entities 130 in the corresponding Meta-Group 140 and encodes the features into embeddings. The system 100 determines, based on the embeddings, edges corresponding to relationships between the entities, and the system 100 may transform the representations to map the edges in the same space as the heterogeneous document network 126. Once transformed, the system 100 may update the representations of the entities 130 to generate the augmented document network graph 142 as output.

Each of the entities 130 in the augmented document network graph 142 may be configured to receive messages from the other entities in Meta-Group 140. The representations of the entities 130 may be updated by looking at the relationships between the entities 130 based on these messages. As such, to generate the augmented document network graph 142, the heterogeneous document network 126 may be augmented with a node 144 corresponding to each one of the Meta-Groups 140, which serves as a hub to enable the exchange of messages between the different entities 130 within the Meta-Group 140.

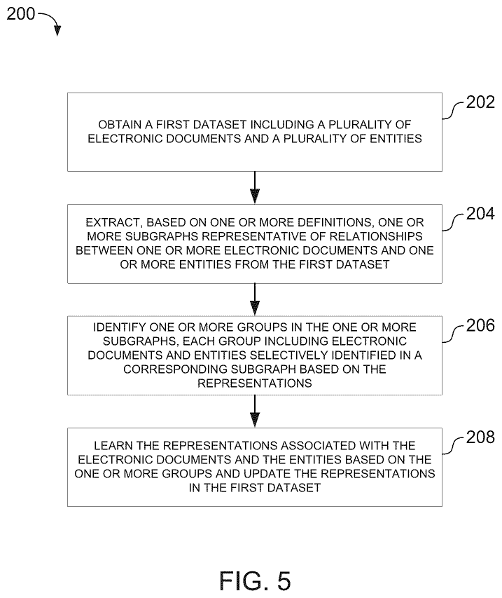

FIG. 5 illustrates a method 200 for determining document similarity, according to some embodiments.

At 202, the method 200 includes obtaining a first dataset of a heterogeneous document network 126 including a plurality of electronic documents and a plurality of entities 130. In some embodiments, the heterogeneous document network 126 may include one or more different entity types. In other embodiments, the heterogeneous document network 126 may include two or more different entity types. In some embodiments, the different entity types may include electronic documents and one or more different types of entities. Additionally, in some embodiments, the electronic documents and the other entities 130 may be associated with a particular user.

The first dataset may include other types of data. The entities 130 in the first dataset may include contextual information associated with each entity 130. In some embodiments, the contextual information may be associated with a particular user. In other embodiments, the contextual information may be associated with one or more users. For example, the contextual information may include, but is not limited to, text data from the electronic documents, user profile data, device data, other data, or any combinations thereof.

The representations in the heterogeneous document network 126 may be built using the contextual information. In this regard, the method 200 may include computing, for the first dataset, one or more vectors corresponding to relationships between the electronic documents and the other entities 130 and mapping the representations to form the heterogeneous document network 126. In some embodiments, the heterogeneous document network 126 may be formed using the contextual information associated with each of the entities 130. In this regard, heterogeneous document network 126 may be formed by initializing the features of the entities 130, determining one or more embeddings based on the features, and encoding the embeddings to selectively identify relationships (e.g., semantic relationships) between the entities 130 in the first dataset and corresponding to representation of the heterogeneous document network 126 as output.

The heterogeneous document network 126 and the contextual information may be associated with a particular user, according to some embodiments. In this regard, the first dataset may include one or more heterogeneous document networks 126, each one of the heterogeneous document networks 126 associated with a particular user of the network of system 100. In other embodiments, the heterogeneous document network 126 may be associated with one or more different users. For example, the first dataset may include user behavior data, device data, IP address data, user profile data, policy rules, other contextual information associated with the user, or any combinations thereof, and corresponding to one or more entities in the heterogeneous document network 126. It is to be appreciated by those having ordinary skill in the art that the type of data included in the datasets is not intended to be limiting and may include one or more different types of data to enable identifying document similarity in accordance with the one or more techniques of the present disclosure.

At 204, the method 200 includes extracting, based on one or more definitions 134 (e.g., rules), one or more Meta-Path sub-graphs 136 representative of relationships between the one or more electronic documents and one or more entities 130 from the first dataset. The one or more definitions 134 define variables or features in the electronic documents and the contextual information of the other entity types which may be associated with the queried representations, according to some embodiments. In some embodiments, the definitions 134 may be associated with a particular user. For example, the definitions 134 may include the IP address of the particular user. Additionally, in some embodiments, the one or more definitions 134 may be provided as input by one or more other users associated with building and maintaining the platform of the heterogeneous document network 126 and the first dataset.

The sub-graph 136 may include a sequence having two or more different entities and corresponding relationships between the entities. In some embodiments, each sub-graph 136 may include one or more sequences, each sequence including two or more types of entities and corresponding vectors between the entities 130 defining the corresponding relationships therebetween.

At 206, the method 200 includes identifying one or more Meta-Groups 140 in the one or more sub-graphs 136, each Meta-Group 140 including electronic documents and entities selectively identified in a corresponding sub-graph 136 based on the representations. In some embodiments, each Meta-Group 140 may be selectively identified from one of the one or more sub-graphs 136. Additionally, the Meta-Group 140 may correspond to a sequence from one of the one or more sub-graphs 136. For example, a subgraph 136 may include a first sequence and a second sequence, and the Meta-Group 140 may correspond to the second sequence.

At 208, the method 200 includes learning the representations associated with the electronic documents and the other entities 130 based on the one or more Meta-Groups 140 and updating the representations of the electronic documents and entities 130 of the first dataset. In some embodiments, learning the representations associated with the electronic documents and the other entities 130 based on the one or more Meta-Groups 140 includes determining encodings based on the text data of the electronic documents and based on the contextual information associated with the entities 130 and encoding the embeddings into one or more vectors indicative of relationships between the entities 130. Additionally, learning the representations may include computing a transformation of the electronic documents and different entities and the one or more vectors determined based on the corresponding Meta-Groups 140 into the same space as the heterogeneous document network 126 of the first dataset.

In some embodiments, learning the representations includes computing one or more nodes 144 and associating each node with the one or more entities 130 in each Meta-Group 140. In this regard, learning the representations may further include augmenting the heterogeneous document network 126 of the first dataset with the nodes 144 and determining relationships between the node 144 and the electronic documents and entities 130 of each corresponding Meta-Group 140. In this regard, the first dataset may be augmented with representations indicative of relationships between the one or more nodes 144 and the entities 130 and electronic documents of a corresponding one of the one or more Meta-Groups 140 to form a second dataset as output.

In some embodiments, the method 200 further includes generating a similarity score between a first document and a second document based on the updated representations in the second dataset. Additionally, the method 200 may further include associating a weighting for each one of the entities 130 based on the transformation and determining the representations based on the weighting, the representations being indicative of relationships between the one or more entities 130 and corresponding to a similarity therebetween.

In some embodiments, the method 200 further includes training a model for determining the representations associated with the one or more entities 130 based on the one or more Meta-Groups 140. In some embodiments, the model may also be trained with the second dataset including the first dataset augmented with the representations including the one or more nodes 144 and relationships to the electronic documents and entities 130 for performing one or more downstream tasks. In some embodiments, the model may be trained to identify downstream instances of fraudulent activity based on the second dataset.

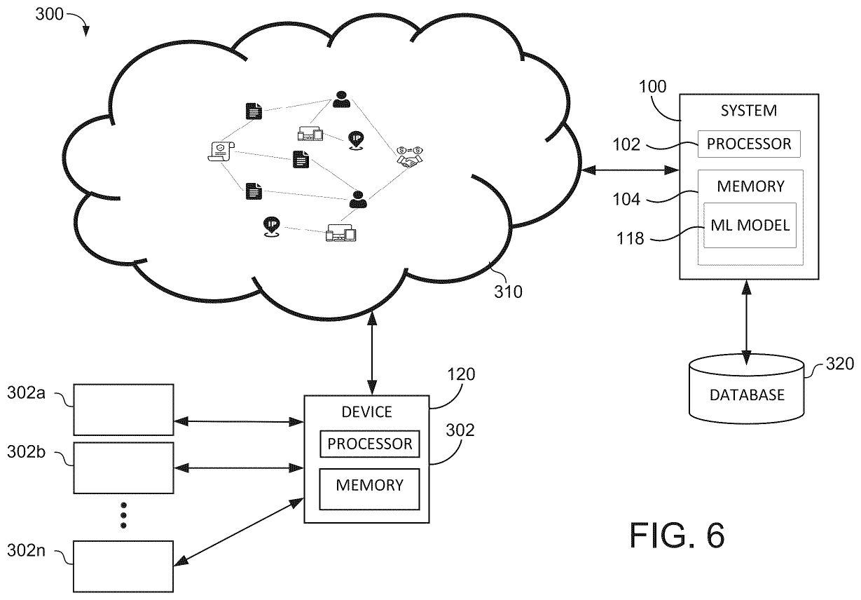

FIG. 6 illustrates a block diagram of a network based system 300, according to some embodiments.

Not all of these components may be required to practice one or more embodiments, and variations in the arrangement and type of the components may be made without departing from the spirit or scope of various embodiments of the present disclosure. In various embodiments, the network based system 300 may include the system 100 of FIG. 1. The system 100 may be in communicable connection with a network 310 to send and receive information corresponding to one or more datasets with one or more other computing devices, such as computing device 120, which may also be in communicable connection with the network 310. In some embodiments, the one or more other computing devices may be a computerized tool (e.g., any suitable combination of computer-executable hardware and/or computer-executable software) which can be configured to perform the one or more methods and techniques in accordance with the present disclosure. For example, in some embodiments, the computing device 120 may be configured, at least in part, to build the heterogeneous document network 126. In another example, the computing device 120 may be configured to, at least in part, learn the representations of the entities 130 for each one of the one or more Meta-Groups 140 to build the augmented document network graph 142.

In some embodiments, the computing device 120 may include a computing device 302. In some embodiments, the system 100 may be in communicable connection with one or more computing devices through network 310. In other embodiments, the system 100 may be in communicable connection with one or more other computing devices through computing device 120. Referring to FIG. 6, system 100 is in communicable connection with computing device 302a through 302n, hereinafter referred to as computing device 302, through network 310 and computing device 120. The system 100 may send and receive data between computing device 120 and/or computing device 302 for performing the document similarity identification.

In some embodiments, the system 100 and the other computing devices may be any type of processor-based platforms that are connected to a network 310 such as, without limitation, servers, personal computers, digital assistants, personal digital assistants, smart phones, pagers, digital tablets, laptop computers, Internet appliances, cloud-based processing platforms, and other processor-based devices either physical or virtual. In some embodiments, the system 100 and the other computing devices may be specifically programmed with one or more application programs in accordance with one or more principles/methodologies detailed herein. In some embodiments, the system 100 and the other computing devices may be specifically programmed with the M.L. component 118 in accordance with one or more principles/methodologies detailed herein. In some embodiments, the system 100 and the other computing devices may operate on any of a plurality of operating systems capable of supporting a browser or browser-enabled application, such as Microsoft™, Windows™, and/or Linux. In some embodiments, the computing device 120 and/or the other computing devices shown each may include at least include a computer-readable medium, such as a random-access memory (RAM) or FLASH memory, coupled to a processor.

In some embodiments, the computing device 120 shown may be accessed by, for example, the system 100 by executing a browser application program such as Microsoft Corporation's Internet Explorer™, Apple Computer, Inc.'s Safari™, Mozilla Firefox, and/or Opera to obtain live data from the network 310. In some embodiments, the system 100 may communicate over the exemplary network 310 with the computing device 120 to obtain live data corresponding to ongoing interactions on the network 310, and which may be analyzed by the system 100 or the other computing devices to perform near real time document similarity identification. For example, the system 100 may process new data obtained from computing device 120 to determine representations indicative of fraudulent transactions.

In some embodiments, the network based system 300 may include at least one database 320. The database 320 may be any type of database, including a database managed by a database management system (DBMS). In some embodiments, an exemplary DBMS-managed database may be specifically programmed as an engine that controls organization, storage, management, and/or retrieval of data in the respective database. In some embodiments, the exemplary DBMS-managed database may be specifically programmed to provide the ability to query, backup and replicate, enforce rules, provide security, compute, perform change and access logging, and/or automate optimization. In some embodiments, the exemplary DBMS-managed database may be chosen from Oracle database, IBM DB2, Adaptive Server Enterprise, FileMaker, Microsoft Access, Microsoft SQL Server, MySQL, PostgreSQL, and a NoSQL implementation. In some embodiments, the exemplary DBMS-managed database may be specifically programmed to define each respective schema of each database in the exemplary DBMS, according to a particular database model of the present disclosure which may include a hierarchical model, network model, relational model, object model, or some other suitable organization that may result in one or more applicable data structures that may include fields, records, files, and/or objects. In some embodiments, the exemplary DBMS-managed database may be specifically programmed to include metadata about the data that is stored.

In some embodiments, the network based system 300 may also include and/or involve one or more cloud components. Cloud components may include one or more cloud services such as software applications (e.g., queue, etc.), one or more cloud platforms (e.g., a Web front-end, etc.), cloud infrastructure (e.g., virtual machines, etc.), and/or cloud storage (e.g., cloud databases, etc.). In some embodiments, the computer-based systems/platforms, computer-based devices, components, media, and/or the computer-implemented methods of the present disclosure may be specifically configured to operate in or with cloud computing/architecture such as, but not limiting to infrastructure a service (IaaS), platform as a service (PaaS), and/or software as a service (SaaS).

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, etc.).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing device (CPU). In various implementations, the one or more processors may be dual-core processor(s), dual-core mobile processor(s), and so forth.

Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, etc.).

In some embodiments, one or more of exemplary inventive computer-based systems/platforms, exemplary inventive computer-based devices, and/or exemplary inventive computer-based components of the present disclosure may include or be incorporated, partially or entirely into at least one personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

As used herein, the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud components and cloud servers are examples.

In some embodiments, as detailed herein, one or more of the computer-based systems of the present disclosure may obtain, manipulate, transfer, store, transform, generate, and/or output any digital object and/or data unit (e.g., from inside and/or outside of a particular application) that can be in any suitable form such as, without limitation, a file, a contact, a task, an email, a message, a map, an entire application (e.g., a calculator), data points, and other suitable data. In some embodiments, as detailed herein, one or more of the computer-based systems of the present disclosure may be implemented across one or more of various computer platforms such as, but not limited to: (1) Linux™, (2) Microsoft Windows™, (3) OS X (Mac OS), (4) Solaris™, (5) UNIX™ (6) VMWare™, (7) Android™, (8) Java Platforms™, (9) Open Web Platform, (10) Kubernetes or other suitable computer platforms. In some embodiments, illustrative computer-based systems or platforms of the present disclosure may be configured to utilize hardwired circuitry that may be used in place of or in combination with software instructions to implement features consistent with principles of the disclosure. Thus, implementations consistent with principles of the disclosure are not limited to any specific combination of hardware circuitry and software. For example, various embodiments may be embodied in many different ways as a software component such as, without limitation, a stand-alone software package, a combination of software packages, or it may be a software package incorporated as a “tool” in a larger software product.

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

In some embodiments, exemplary inventive computer-based systems/platforms, exemplary inventive computer-based devices, and/or exemplary inventive computer-based components of the present disclosure may be configured to output to distinct, specifically programmed graphical user interface implementations of the present disclosure (e.g., a desktop, a web app., etc.). In various implementations of the present disclosure, a final output may be displayed on a displaying screen which may be, without limitation, a screen of a computer, a screen of a mobile device, or the like. In various implementations, the display may be a holographic display. In various implementations, the display may be a transparent surface that may receive a visual projection. Such projections may convey various forms of information, images, and/or objects. For example, such projections may be a visual overlay for a mobile augmented reality (MAR) application.

In some embodiments, exemplary inventive computer-based systems/platforms, exemplary inventive computer-based devices, and/or exemplary inventive computer-based components of the present disclosure may be configured to be utilized in various applications which may include, but not limited to, gaming, mobile-device games, video chats, video conferences, live video streaming, video streaming and/or augmented reality applications, mobile-device messenger applications, and others similarly suitable computer-device applications.

In some embodiments, the exemplary inventive computer-based systems/platforms, the exemplary inventive computer-based devices, and/or the exemplary inventive computer-based components of the present disclosure may be configured to securely store and/or transmit data by utilizing one or more of encryption techniques (e.g., private/public key pair, Triple Data Encryption Standard (3DES), block cipher algorithms (e.g., IDEA, RC2, RC5, CAST and Skipjack), cryptographic hash algorithms (e.g., MD5, RIPEMD-160, RTR0, SHA-1, SHA-2, Tiger (TTH), WHIRLPOOL, RNGs).

The machine learning model as described in the various embodiments herein can be any suitable computer-implemented artificial intelligence algorithm that can be trained (e.g., via supervised learning, unsupervised learning, and/or reinforcement learning) to receive input data and to generate output data based on the received input data (e.g., neural network, linear regression, logistic regression, decision tree, support vector machine, naive Bayes, and/or so on). In various aspects, the input data can have any suitable format and/or dimensionality (e.g., character strings, scalars, vectors, matrices, tensors, images, and/or so on). Likewise, the output data can have any suitable format and/or dimensionality (e.g., character strings, scalars, vectors, matrices, tensors, images, and/or so on). In various embodiments, a machine learning model can be implemented to generate any suitable determinations and/or predictions in any suitable operational environment (e.g., can be implemented in a payment processing context, where the model receives payment data, transaction data, and/or customer data and determines/predicts whether given transactions are fraudulent, whether given customers are likely to default, and/or any other suitable financial determinations/predictions, and/or so on).

In some embodiments, a system includes a processor and a non-transitory computer readable medium having stored thereon instructions that are executable by the processor to cause the system to perform operations including obtaining a first dataset including a plurality of electronic documents and a plurality of entities, extracting, based on one or more rules, one or more subgraphs including representations between one or more electronic documents and one or more entities from the first dataset, identifying one or more groups in the one or more subgraphs, each group including electronic documents and entities selectively identified from a corresponding subgraph based on the representations, and learning, using a neural network, the representations associated with the electronic documents and the entities based on the one or more groups and update the representations in the first dataset. In some embodiments, the first dataset includes one or more data types including user behavior data, device data, IP addresses, user profiles, and policy rules, or other contextual information associated with a network structure.

In some embodiments, the operations further include computing, for the first dataset, one or more first vectors representative of relationships between the electronic documents and the entities. In some embodiments, the one or more rules define paths representative of relationships between the one or more entities to enable extraction of each of the one or more subgraphs from the first dataset. In some embodiments, the one or more rules are defined based on one or more inputs provided by a user associated with a server of the system.

In some embodiments, identifying the one or more groups further includes computing one or more nodes and associating each node with the one or more entities in each group of the one or more groups from the first dataset, and generating a second dataset including the first dataset augmented with the one or more groups and the one or more nodes.

In some embodiments, the operations may further include training a model for determining the representations associated with the one or more entities based on the one or more groups. In some embodiments, training the model for determining the representations associated with the one or more entities includes encoding text data of the one or more entities into one or more second vectors, computing a transformation of the one or more second vectors into a second mapping, and associating a weighting for each entity based on the transformation, the representations being indicative of relationships between the one or more entities determined based on the weighting.

In some embodiments, the operations further include generating a similarity score between a first document and a second document based on the updated representations of the first dataset.

In some embodiments, a computer-implemented method for using neural networks to determine electronic document similarity includes obtaining, by a computer system, a first dataset including a plurality of electronic documents and a plurality of entities, computing, by the computer system using a first model, a selective mapping between the plurality of electronic documents and the plurality of entities based on one or more first vectors indicative of relationships, extracting, by the computer system and based on one or more rules, one or more subgraphs including one or more electronic documents and one or more entities based on the selective mapping of the first dataset, identifying, by the computer system, one or more groups in the one or more subgraphs, each group including electronic documents and entities from a corresponding subgraph based on the relationships therebetween, updating, by the computer system, representations associated with the first dataset based on the one or more groups, and training, by the computer system, an updated model for determining relationships between the plurality of electronic documents and the plurality of entities based on the updated representations.

In some embodiments, the method further includes determining a node for each group of the one or more groups and determining one or more second vectors representative of relationships between the node and the electronic documents and entities of each group, and determining, by the computer system, a second dataset including a second mapping including the first dataset and the updated representations therebetween. In some embodiments, updating the representations associated with the first dataset based on the one or more groups further includes encoding, by the computer system, one or more second vectors based on text data from the electronic documents and the entities, the one or more second vectors indicative of relationships between the electronic documents and the entities in each group, associating a weighting with each of the one or more second vectors, and determining, by the computer system using the updated model, a second mapping based on the first dataset and the one or more groups and based on the one or more second vectors.

In some embodiments, a method, further includes detecting, by a neural network using the updated model, a binary malicious attack based on applying the updated model to a dataset. In some embodiments, the method further includes generating, by the computer system, a similarity score between a first document and a second document based on applying the updated model to the first document and the second document. In some embodiments, the first dataset includes one or more of user behavior data, device data, IP addresses, user profiles, and policy rules, or other contextual information associated with a network structure.

In some embodiments, a non-transitory computer readable medium having stored thereon instructions that are executable by a processor of a computing device to cause the computing device to perform operations including computing, for a first dataset, a selective mapping of a plurality of electronic documents and a plurality of entities and including one or more first vectors representative of relationships therebetween, extracting, based on one or more rules, one or more subgraphs including one or more electronic documents and one or more entities of the first dataset based on the relationships therebetween, identifying one or more groups in the one or more subgraphs, each group including electronic documents and entities and corresponding relationships therebetween, determining a node for each group of the one or more groups and determining one or more second vectors representative of relationships between the electronic documents and the entities of each group and corresponding node, and updating, using a neural network, representations associated with the first dataset based on the one or more groups and the corresponding nodes, the first dataset including one or more of user behavior data, device data, IP addresses, user profiles, and policy rules, or other contextual information associated with a network structure.

In some embodiments, the operations further include determining a weighting associated with each of the one or more second vectors, the representations included in the second mapping being determined based on the weighting associated with each of the one or more second vectors connecting the electronic documents and the entities to the corresponding node. In some embodiments, the operations further include obtaining the first dataset including the plurality of electronic documents and the plurality of entities. In some embodiments, the operations further include training a model for determining the representations between documents and entities based on the one or more groups and the corresponding node. In some embodiments, the operations further include generating a similarity score between a first document and a second document based on applying the model to the first document and the second document.

The various embodiments described herein can improve computer performance by reducing the processing requirements for datasets, thereby saving processor cycles, the number of required processors, memory usage, and power usage. Techniques herein can also improve computer performance by providing more efficient data processing models for identifying document similarity using heterogeneous group relationships based on contextual information, as performed by the one or more processors and one or more machine learning models, leading to improved computing systems or networked computing systems that are implemented by one or more computing devices, servers, controllers, other computing devices, and the like, and thereby saving on processor cycles, memory usage, and power usage by those devices.

All prior patents and publications referenced herein are incorporated by reference in their entireties.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

What is claimed is:

1. A system comprising:
a processor; and
a non-transitory computer readable medium having stored thereon instructions that are executable by the processor to cause the system to perform operations comprising:
obtain a first dataset comprising a plurality of electronic documents and a plurality of entities;
extract, based on one or more definitions, one or more subgraphs comprising representations between one or more electronic documents and one or more entities from the first dataset;
identify one or more groups in the one or more subgraphs, each group comprising electronic documents and entities selectively identified from a corresponding subgraph based on the representations; and
learn, using a neural network, the representations associated with the electronic documents and the entities based on the one or more groups and update the representations in the first dataset.

2. The system according to claim 1, wherein the first dataset comprises one or more of user behavior data, device data, IP addresses, user profiles, and policy definitions, or other contextual information associated with a network structure.

3. The system according to claim 1, wherein the operations further comprise:
compute, for the first dataset, one or more first vectors representative of relationships between the electronic documents and the entities.

4. The system according to claim 1, wherein the one or more definitions define paths representative of relationships between the one or more entities to enable extraction of each of the one or more subgraphs from the first dataset.

5. The system according to claim 4, wherein the one or more definitions are defined based on one or more inputs provided by a user associated with a server of the system.

6. The system according to claim 1, wherein identifying the one or more groups further comprises:
compute one or more nodes and associate each node with the one or more entities in each group of the one or more groups, and
generate a second dataset including the first dataset augmented with the one or more groups and the one or more nodes.

7. The system according to claim 1, wherein the operations further comprise:
train a model for determining the representations associated with the one or more entities based on the one or more groups.

8. The system according to claim 7, wherein training the model for determining the representations associated with the one or more entities comprises:
encode text data of the one or more entities into one or more second vectors,
compute a transformation of the one or more second vectors into a second mapping, and
associate a weighting for each entity based on the transformation,
wherein the representations are indicative of relationships between the one or more entities determined based on the weighting.

9. The system according to claim 1, wherein the operations further comprise:
generate a similarity score between a first document and a second document based on updated representations of the first dataset.

10. A computer-implemented method for using neural networks to determine electronic document similarity, comprising:
obtaining, by a computer system, a first dataset comprising a plurality of electronic documents and a plurality of entities;
computing, by the computer system using a first model, a selective mapping between the plurality of electronic documents and the plurality of entities based on one or more first vectors indicative of relationships therebetween;
extracting, by the computer system and based on one or more definitions, one or more subgraphs comprising one or more electronic documents and one or more entities based on the selective mapping of the first dataset;
identifying, by the computer system, one or more groups in the one or more subgraphs, each group comprising electronic documents and entities from a corresponding subgraph based on the relationships therebetween;
updating, by the computer system, representations associated with the first dataset based on the one or more groups; and
training, by the computer system, an updated model for determining relationships between the plurality of electronic documents and the plurality of entities based on the updated representations.

11. The method according to claim 10, further comprising:
determining a node for each group of the one or more groups and determining one or more second vectors representative of relationships between the node and the electronic documents and entities of each group; and
determining, by the computer system, a second dataset comprising a second mapping including the first dataset and updated representations therebetween.

12. The method according to claim 11, wherein updating the representations associated with the first dataset based on the one or more groups further comprises:
encoding, by the computer system, one or more second vectors based on text data from the electronic documents and the entities, the one or more second vectors indicative of relationships between the electronic documents and the entities in each group,
associating a weighting with each of the one or more second vectors, and
determining, by the computer system using the updated model, a second mapping based on the first dataset and the one or more groups and based on the one or more second vectors.

13. The method according to claim 10, further comprising:
detecting, by a neural network using the updated model, a binary malicious attack based on applying the updated model to a dataset.

14. The method according to claim 10, further comprising:
generating, by the computer system, a similarity score between a first document and a second document based on applying the updated model to the first document and the second document.

15. The method according to claim 10, wherein the first dataset comprises one or more of user behavior data, device data, IP addresses, user profiles, and policy definitions, or other contextual information associated with a network structure.

16. A non-transitory computer readable medium having stored thereon instructions that are executable by a processor of a computing device to cause the computing device to perform operations comprising:
computing, for a first dataset, a selective mapping of a plurality of electronic documents and a plurality of entities and including one or more first vectors representative of relationships therebetween;
extracting, based on one or more definitions, one or more subgraphs comprising one or more electronic documents and one or more entities of the first dataset based on the relationships therebetween;
identifying one or more groups in the one or more subgraphs, each group comprising electronic documents and entities and corresponding relationships therebetween;
determining a node for each group of the one or more groups and determining one or more second vectors representative of relationships between the electronic documents and the entities of each group and corresponding node; and
updating, using a neural network, representations associated with the first dataset based on the one or more groups and corresponding nodes;
wherein the first dataset comprises one or more of user behavior data, device data, IP addresses, user profiles, and policy definitions, or other contextual information associated with a network structure.

17. The computing device according to claim 16, wherein the operations further comprise:
determining a weighting associated with each of the one or more second vectors,
wherein updated representations are determined based on the weighting associated with each of the one or more second vectors connecting the electronic documents and the entities to the corresponding node.

18. The computing device according to claim 16, wherein the operations further comprise:
obtaining the first dataset comprising the plurality of electronic documents and the plurality of entities.

19. The computing device according to claim 16, wherein the operations further comprise:
train a model for determining the representations between documents and entities based on the one or more groups and the corresponding node.

20. The computing device according to claim 19, wherein the operations further comprise:
generating a similarity score between a first document and a second document based on applying the model to the first document and the second document.
